(19) United States
(12) Patent Application Publication
(10) Pub. No.: US 2017/0293315 A1
(43) Pub. Date: Oct. 12, 2017

(54) TENSIONING/DISPLACEMENT SYSTEM THAT IS ACTUATED/ACTIVATED DOWNWARDS VIA A PEDAL COUPLED WITH/TO A LEVER WHICH, WHEN ACTUATED/ACTIVATED UPWARDS, NOT ONLY RELEASES/REMOVES THE TENSION, BUT ALSO REVERSES THE DISPLACMENT AND AUTOMATICALLY CAUSES THE PEDAL TO BE RESET/REPOSITIONED TO THE PEDAL'S POSITION BEFORE THE PEDAL ACUTATED/ACTIVATED THE TENSIONING/DISPLACEMENT SYSTEM

(71) Applicants: Robert Alan Bard, Loveladies, NJ (US); Douglas Aaron Bard, Brielle, NJ (US)

(72) Inventors: Robert Alan Bard, Loveladies, NJ (US); Douglas Aaron Bard, Brielle, NJ (US)

(21) Appl. No.: 15/093,434

(22) Filed: Apr. 7, 2016

(51) Int. Cl. G05G 1/30; G05G 5/05

(52) U.S. Cl. CPC G05G 1/30; G05G 5/05

(57) ABSTRACT

A tensioning/displacement system that is actuated/activated downwards via a pedal coupled with/to a lever which, when actuated/activated upwards, not only releases/removes the tension, but also reverses the displacement and automatically causes the pedal to be reset/repositioned to the pedal's position before the pedal actuated/activated the tensioning/displacement system. The present invention is based on as well as being a derivation of our related patent U.S. Pat. No. 8,978,295 B2 which was invented by us, Robert Alan Bard and Douglas Aaron Bard.

This invention had emanated from the need of the device described in U.S. Pat. No. 8,978,295, B2 which, among other things, also serves as a Christmas Tree stand, such that there is a need for an additional tension/displacer to increase the pressure/force of the jaw emembers/grippers of U.S. Pat. No. 8,978,295 B2 on the Christmas Tree.

This invention is also based on the provisional patent application #62/178,868 submitted with a filing date of Apr. 21, 2015.

### BACKGROUND OF INVENTION

This invention emanated from the need of U.S. Pat. No. 8,978,295 B2 which, among other things, also serves as a Christmas tree stand such that there is a need for the tensioner/displacer to increase the pressure/force of the jaw members/grippers of U.S. Pat. No. 8,978,295 B2 on the Christmas Tree.

### BRIEF SUMMARY OF INVENTION

A tensioning/displacement system that is actuated/activated downwards via a pedal coupled with/to a lever which, when actuated/activated upwards not only releases/removes the tension but also reverses the displacement and automatically causes the pedal to be reset/repositioned to the pedal's position before the pedal actuated/activated the tensioner/displacement system.

### BRIEF DESCRIPTION OF DRAWINGS

FIGS. 1, 2 and 3 show the front, side and top views respectively of the tensioning/displacement system in the non-locked as well as the non-loaded, non-tensioned and non-displaced state. FIGS. 4, 5 and 6 show the front, side and top views respectively of the tensioning/displacement system in the locked as well as the loaded, tensioned and displaced state.

### DETAILED DESCRIPTION OF INVENTION

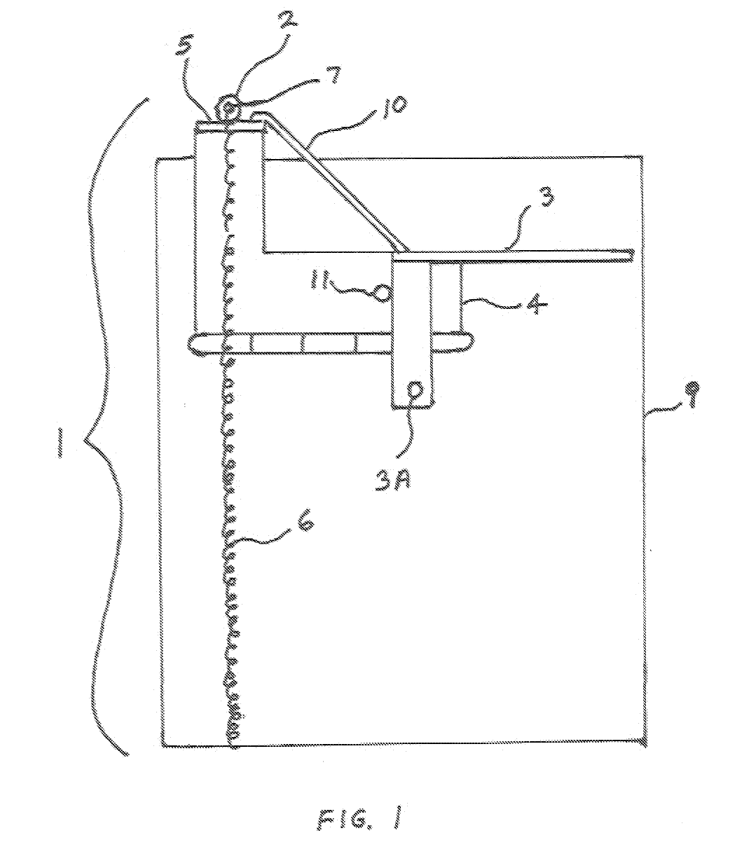

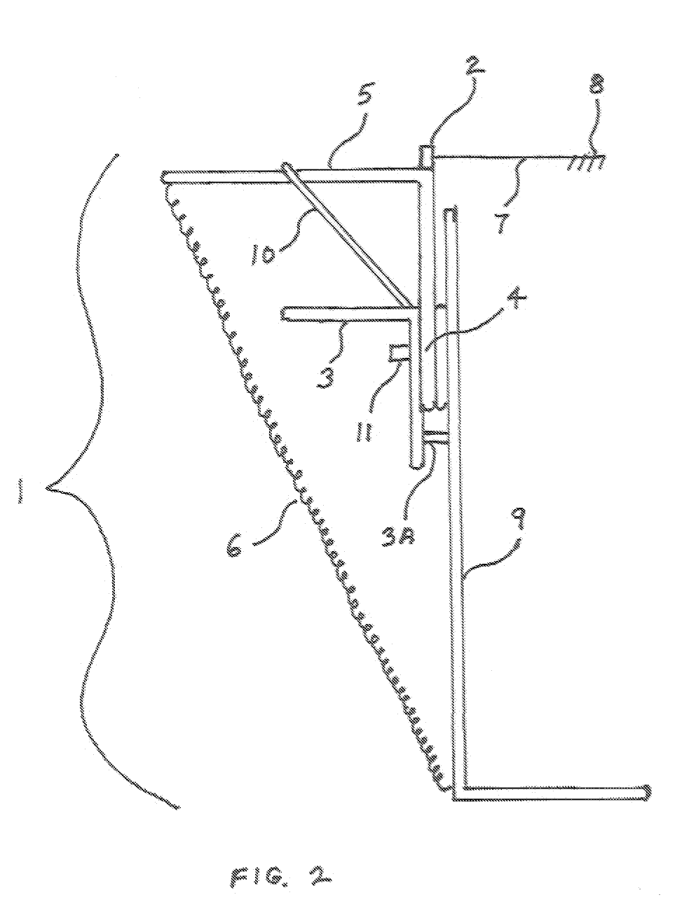

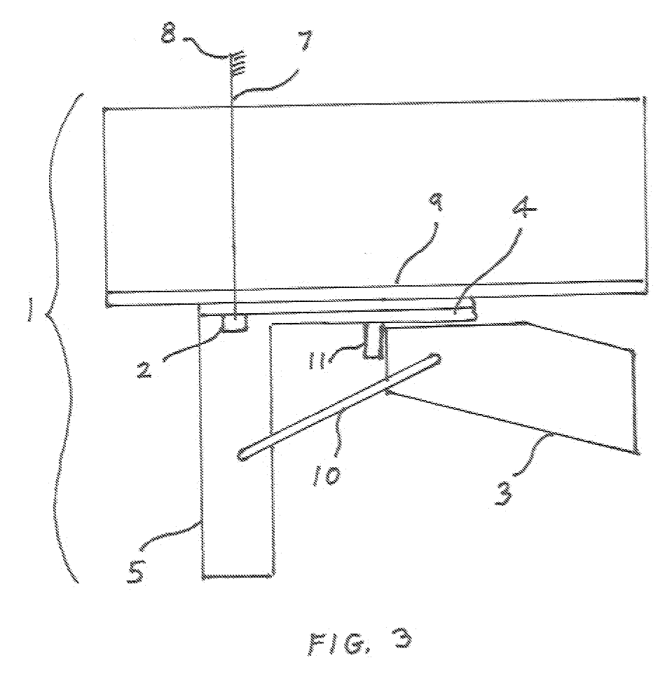

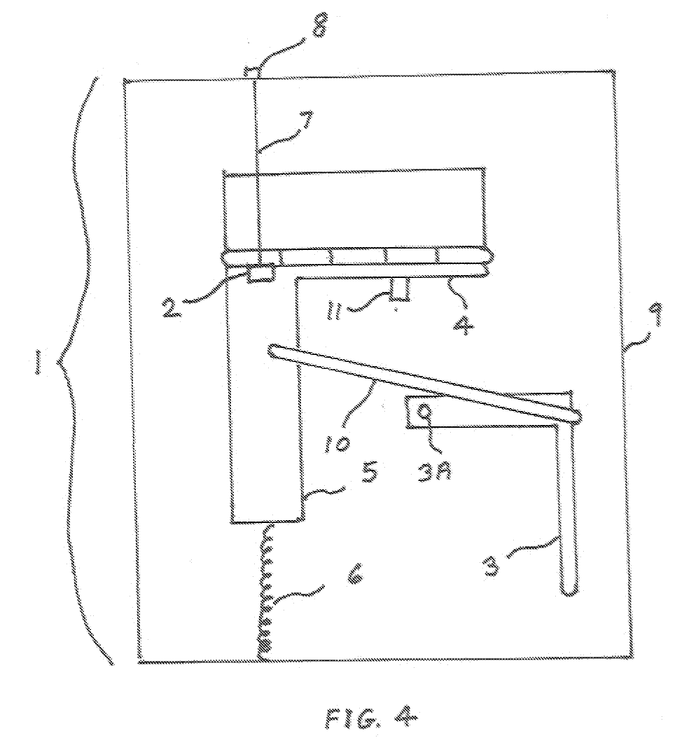

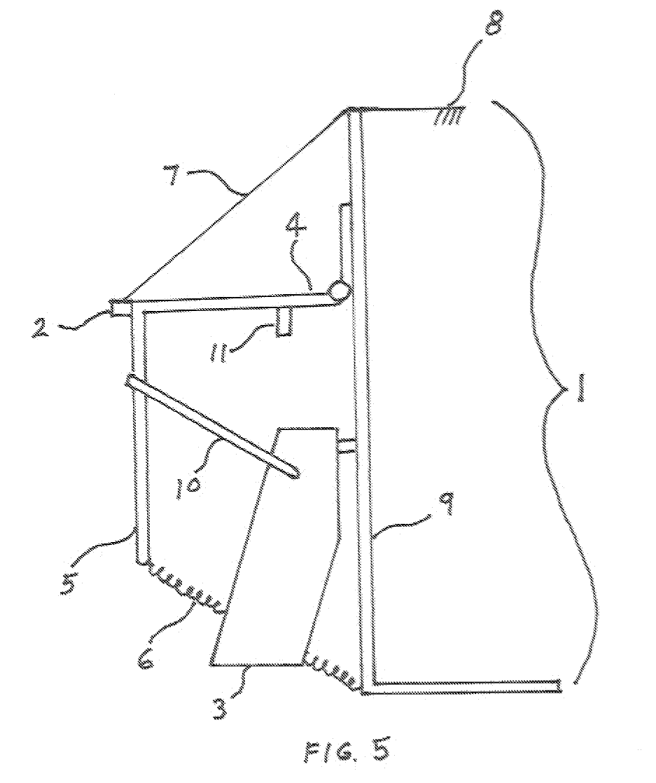

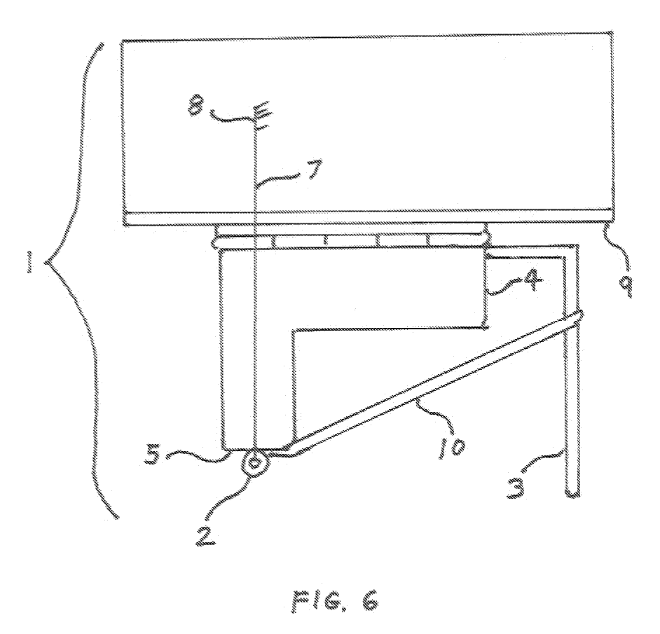

FIGS. 1, 2 and 3 show the front, side and top views respectively of the device's 1 cleat 2 in the cleat's 2 initial non-locked/non-loaded/non-tensioned/non-displaced position while FIGS. 4, 5 and 6 show the cleat 2 in the locked/loaded/tensioned/displaced position. The displacement of the cleat 2 from the cleat's2 initial non-locked/non-loaded/non-tensioned/non-displaced position is caused to occur as the pedal 3 is depressed downward as follows:

Starting with the device 1 in the non-locked/non-loaded/non-tensioned/non-displaced position as shown in FIGS. 1, 2 and 3, the pedal 3 is then depressed down to the extent that the entire pedal 3 rotates about its pivot pin 3A clear of the hinged portion 4 of the lever 5 such that the spring 6 which is in the tension mode is now free to pull down the lever 5 and thus the cleat 2 mounted on the lever 5 in turn causing tension in item 7 which can be a string, cable or chain etc. attached to the cleat 2 at one end and also attached to a fixed point 8 which is at the other end and which is also located at a distance away from the side of the mounting board 9 which does not support either the pedal 3 or the lever 5. The end result of the foregoing operation is that the device 1 is in the locked/loaded/tensioned/displaced position as shown in FIGS. 4, 5 and 6. To re-establish the device 1 to be in the non-locked/non-loaded/non-tensioned/non-displaced position, the following must occur: the lever 5 is then lifted back up to the lever 5's original non-locked/non-loaded/non-tensioned/non-displaced position as shown in FIGS. 1, 2 and 3 and then, because of the connection of the elastic cord 10 from the lever 5 to the pedal 3, the pedal 3 is pulled back up/reset against the stop 11, which is mounted perpendicularly on the hinged portion 4 of the lever 5, to the pedal's 3 initial non-locked/non-loaded/non-tensioned/non-displaced position and as such the device 1 is ready to be shifted again from the non-locked/non-loaded/non-tensioned/non-displaced position to the locked/loaded/tensioned/displaced position.

What we claim our invention is:

1. A device for placing tension on an item which when in tension, is aligned linear such as along a string, cord, cable, chain etc. comprising:
a board on one side of which the device is mounted and which is herein subsequently referred to as the mounting board and additionally which is orientated in the vertical/upright plane or the approximately vertical/upward plane.
a pedal which can rotate downward or upward in a plane perpendicular to its rotational axis which is perpendicular or approximately perpendicular to the mounting board
a lever incorporated as part of one side of a hinge and attached perpendicularly to that one side of the hinge such that as that one side of the hinge rotates away from the other side of the hinge which is fully mounted to the mounting board the portion of the lever which is farthest from the hinge's pivot point, moves downward such that the foregoing transpires when the pedal is rotated to the extent that the pedal no longer blocks the hinge's portion of the lever thus allowing the lever and its hinged portion to rotate downward in a plane perpendicular to the axis of the hinge
a cleat mounted on the lever at the location where the lever portion of the hinge meets the non-lever portion of the hinge and is also perpendicular to the non-lever portion of the hinge such that as the end of the lever farthest from the pivot point of the hinge moves downward the cleat moves further away from the mounting board allowing the cleat to put tension on an item such as a string, cord, rope, cable, chain etc. which has one end attached to the cleat and the other end attached at a location which is in the region that is a distance from the side of the mounting board on which the hinge is not mounted. The location of the other non-cleated end is, however, subject to displacement when put under tension due to the movement of the cleat away from the other non-cleated end, a movement which in turn, is caused by the movement of the lever to which the cleat is attached.
a stop mounted on the hinge portion of the lever to prevent the counter-clockwise motion of the pedal assembly past the vertical position
a spring or other elastic medium that is connected from the non-cleated end of the lever to the base of the mounting board such that when the lever is free to rotate downward the tension in the spring increases the speed of rotation of the lever as well as the pulling/tension force that the lever can exert against anything that tries to prevent the lever's downward movement/motion.
a spring or other elastic medium which connects the pedal to the lever such that as the lever is brought back to the lever's initial non-locked/non-loaded/non-tensioned/non-displaced position which existed before the pedal was rotated downward, the spring or other elastic medium causes the pedal to be pulled back up against the stop up to the pedal's non-actuated/non-activated state, in other words, the pedal has become reset. An integral part of causing the foregoing to occur is that as the lever is brought back to the lever's initial non-locked/non-tensioned/non-displaced position the hinged portion of the lever becomes positioned so as not to block any portion of the pedal's assembly from moving back to the pedal assembly's initial position against the stop.
